(19) United States
(12) Patent Application Publication
(10) Pub. No.: US 2016/0036837 A1
(43) Pub. Date: Feb. 4, 2016

(54) DETECTING ATTACKS ON DATA CENTERS

(71) Applicant: Microsoft Corporation, Redmond, WA (US)

(72) Inventors: Navendu Jain, Seattle, WA (US); Rui Miao, Los Angeles, CA (US)

(21) Appl. No.: 14/450,954

(22) Filed: Aug. 4, 2014

(51) Int. Cl. H04L 29/06

(52) U.S. Cl. CPC H04L 63/1416; H04L 63/1458

(57) ABSTRACT

The claimed subject matter includes a system and method for detecting attacks on a data center. The method includes sampling a packet stream by coordinating at multiple levels of data center architecture, based on specified parameters. The method also includes processing the sampled packet stream to identify one or more data center attacks. Further, the method includes generating attack notifications for the identified data center attacks.

### BACKGROUND

Datacenter attacks are cyber attacks targeted at the datacenter infrastructure, or the applications and services hosted in the datacenter. Services, such as cloud services, are hosted on elastic pools of computing, network, and storage resources made available to service customers on-demand. However, these advantages (such as elasticity, on-demand availability), also make cloud services a popular target for cyberattacks. A recent survey indicates that half of datacenter operators experienced denial of service (DoS) attacks, with a great majority experiencing cyberattacks on a continuing, and regular basis. The DoS attack is an example of a network-based attack. One type of a DoS attack sends a large volume of packets to the target of the attack. In this way, the attackers consume resources such as, connection state at the target (e.g., target of TCP SYN attacks) or incoming bandwidth at the target (e.g., UDP flooding attacks). When the bandwidth resource is overwhelmed, legitimate client requests are not be able to get serviced by the target.

In addition to DoS attacks, there are also distributed DoS (DDos) attacks, and other types of both network-based and application-based attacks. An application-based attack compromises vulnerabilities, e.g., security holes in a protocol or application design. One example of an application-based attack is a slow HTTP attack, which takes advantage of the fact that HTTP requests are not processed until completely received. If an HTTP request is not complete, or if the transfer rate is very low, the server keeps its resources busy waiting for the rest of the data. In a slow HTTP attack, the attacker keeps too many resources needlessly busy at the targeted web server, effectively creating a denial of service for its legitimate clients. Attacks include a diverse range of type, complexity, intensity, duration and distribution. However, existing defenses are typically limited to specific attack types, and do not scale to the traffic volumes of many cloud providers. For these reasons, detecting and mitigating cyberattacks at the cloud scale is a challenge.

### SUMMARY

The following presents a simplified summary of the innovation in order to provide a basic understanding of some aspects described herein. This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

A system and method for detecting attacks on a data center samples a packet stream by coordinating at multiple levels of data center architecture, based on specified parameters. The sampled packet stream is processed to identify one or more data center attacks. Further, attack notifications are generated for the identified data center attacks.

Implementations include one or more computer-readable storage memory devices for storing computer-readable instructions. The computer-readable instructions when executed by one or more processing devices, detect attacks on a data center. The computer-readable instructions include code configured to determine, based on a packet stream for the data center, granular traffic volumes for a plurality of specified time granularities. Additionally, the packet stream is sampled at multiple levels of data center architecture, based on the specified time granularities. Data center attacks occurring across one or more of the specified time granularities are identified based on the sampling. Further, attack notifications for the data center attacks are generated.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an example system for detecting datacenter attacks, according to implementations described herein;

FIGS. 2A-2B are tables summarizing network features of datacenter attacks, according to implementations described herein;

FIGS. 3A-3B are block diagrams of an attack detection system, according to implementations described herein;

FIG. 4 is a block diagram of an attack detection pipeline, according to implementations described herein;

FIG. 5 is a process flow diagram of a method for analyzing datacenter attacks, according to implementations described herein;

FIG. 6 is a block diagram of an example system for detecting datacenter attacks, according to implementations described herein;

FIG. 7 is a block diagram of an exemplary networking environment for implementing various aspects of the claimed subject matter; and

FIG. 8 is a block diagram of an exemplary operating environment for implementing various aspects of the claimed subject matter.

### DETAILED DESCRIPTION

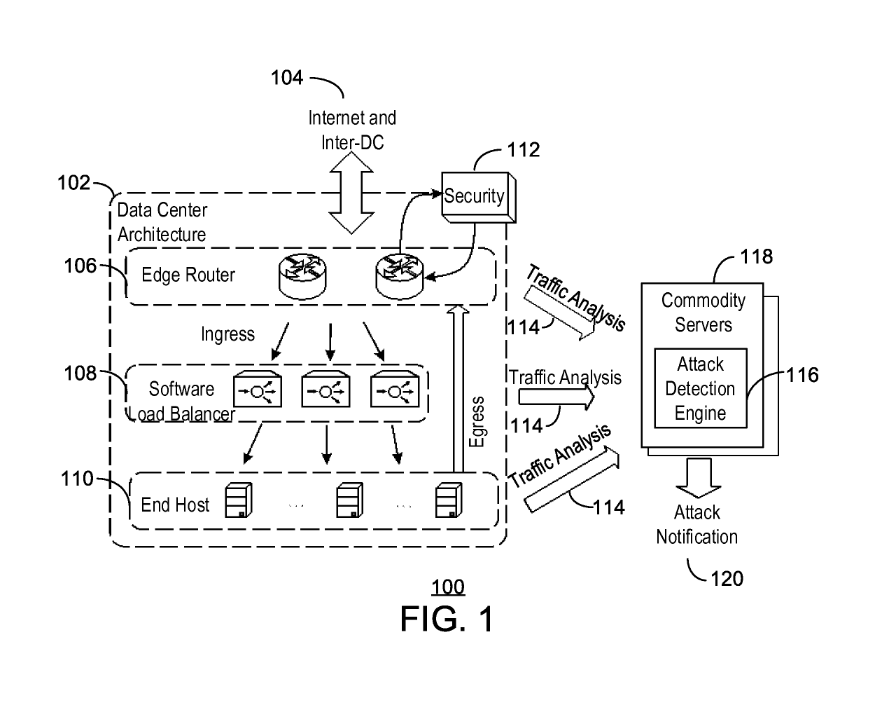

As a preliminary matter, some of the Figures describe concepts in the context of one or more structural components, variously referred to as functionality, modules, features, elements, or the like. The various components shown in the Figures can be implemented in any manner, such as software, hardware, firmware, or combinations thereof. In some implementations, various components reflect the use of corresponding components in an actual implementation. In other implementations, any single component illustrated in the Figures may be implemented by a number of actual components. The depiction of any two or more separate components in the Figures may reflect different functions performed by a single actual component. FIG. 1, discussed below, provides details regarding one system that may be used to implement the functions shown in the Figures.

Other Figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may include communication media such as transmission media for wireless signals and the like.

Cloud providers may host thousands to tens of thousands of different services. As such, attacking cloud infrastructure can cause significant collateral damage, which may entice attention-seeking cyber attackers. Attackers can use hosted services or compromised VMs in the cloud to launch outbound attacks, intra-datacenter attacks, host malware, steal confidential data, disrupt a competitor's service, sell compromised VMs in the underground economy, among other reasons. Intra-datacenter attacks are when a service attacks another service hosted in the same datacenter, Attackers have also been known to use cloud VMs to deploy botnets, exploit kits to detect vulnerabilities, send spam, or launch DoS attacks to other sites, among other malicious activities.

To help organize this variety of cyber attacks, implementations of the claimed subject matter analyze the big picture of network-based attacks in the cloud, characterize outgoing attacks from the cloud, describe the prevalence of attacks, their intensity and frequency, and provide spatio-temporal properties as the attacks evolve over time. In this way, implementations provide a characterization of network-based attacks on cloud infrastructure and services. Additionally, implementations enable the design of an agile, resilient, and programmable service for detecting and mitigating these attacks.

For data on the prevalence and variety of attacks, an example implementation may be constructed for a large cloud provider, typically with over hundreds of terabytes (TB) of logged network traffic data over a time window. Using example data such as this may indicate its collection from edge routers spread across multiple, geographically-distributed data centers. The present techniques were implemented with a methodology to estimate attack properties for a wide variety of attacks, both on the infrastructure and services. Various types of cloud attacks to consider include: volumetric attacks (e.g., TCP SYN flood, UDP bandwidth floods, DNS reflection), brute-force attacks (e.g., on RDP, SSH and VNC sessions), spread-based attacks on specific identifiers in fivetuple defined flows (e.g., spam, SQL server vulnerabilities), and communication-based attacks (e.g., sending or receiving traffic from Traffic Distribution Systems). Additionally, the cloud deploys a variety of security mechanisms and protection devices such as firewalls, IDPS, and DDoS-protection appliances to effectively defend against these attacks.

Implementations are able to scale to handle over 100 Gbps of attack traffic in the worst case. Further, outbound attacks often match inbound attacks in intensity and prevalence, but the types of attacks seen are qualitatively different based on the inbound or outbound direction. Moreover, attack throughputs may vary by 3-4 orders of magnitude, median attack ramp-up time in the outbound direction is a minute, and outbound attacks also have smaller inter-arrival times than inbound attacks. Taken together, these results suggest that the diversity, traffic patterns, and intensity of cloud attacks represent an extreme point in the space of attacks that current defenses are not equipped to handle.

Implementations provide a new paradigm of attack detection and mitigation as additional services of the cloud provider. In this way, commodity VMs may be leveraged for attack detection. Further, implementations combine the elasticity of cloud computing resources with programmability similar to software-defined networks (SDN). The approach enables the scaling of resource use with traffic demands, provides flexibility to handle attack diversity, and is resilient against volumetric or complex attacks designed to subvert the detection infrastructure. Implementations may include a controller that directs different aggregates of network traffic data to different VMs, each of which detects attacks destined for different sets of cloud services. Each VM can be programmed to detect the wide variety of attacks discussed above, and when a VM is close to resource exhaustion, the controller can divert some of its traffic to other, possibly newly instantiated, VMs Implementations scale VMs to minimize traffic redistributions, devise interfaces between the controller and the VMs, and determine a clean functional separation between user and kernel-space processing for traffic. One example implementation uses servers with 10G links, and can quickly scale-out virtual machines to analyze traffic at line speed, while providing reasonable accuracy for attack detection.

A typical approach to detecting cyberattacks in cloud computing systems is to use a traffic volume threshold. The traffic volume threshold is a predetermined number that indicates a cyberattack may be occurring when the traffic volume in a router exceeds the threshold. The threshold approach is useful for detecting attacks such as DDoS. However, the DDoS merely represents one type of inbound, network-based attack. Yet, outbound attacks often match inbound attacks in intensity and prevalence, but are qualitatively different in the types of attacks.

Implementations of the claimed subject matter provide large-scale characterization of attacks on and off the cloud infrastructure Implementations incorporate a methodology to estimate attack properties for a wide variety of attacks both on the infrastructure and services. In one implementation, four classes of network-based techniques, both independently and in coordination, are used to detect cyberattacks. These techniques use the volume, spread, signature and communication patterns of network traffic to detect cyberattacks Implementations also verify the accuracy of these techniques, using common network data sources such as incident reports, commercial security appliance generated alerts, honeypot data, and a blacklist of malicious nodes on the Internet.

In one implementation, sampling is coordinated across different levels of the cloud infrastructure. For example, the entire IP address range may be divided across levels, e.g., inbound or outbound traffic for addresses 1.x.x.x to 63.255.255.255 are sampled at level 1; addresses 64.x.x.x to 127.255.255.255 are sampled at level 2; addresses 128.x.x.x to 255.255.255.255 are sampled at level 3; and, so on. Similarly, the destination IP addresses or ranges of VIP addresses may be partitioned across levels. In general, the coordination for sampling can be along any combination of IP address, port, protocol. In another implementation, coordination may be partitioned by customer traffic (e.g., high business impact (HBI), medium business impact (MBI), low priority). Sampling rates and time granularities may also differ at different levels of the hierarchy.

Advantageously, by applying these techniques, it is possible to count the number of incidents for a variety of attacks, and quantify the traffic pattern for RDP, SSH and VNC brute-force attacks, and SQL vulnerability attacks, which are normally identified at the host application layer Implementations also make it possible to observe and analyze traffic abnormalities in other security protocols, including IPv4 encapsulation and EPS, for which attack detection is typically challenging. Additionally, implementations make it possible to find the origin of the attack by geo-locating the top-k autonomous systems (ASes) of attack sources. The Internet is logically divided into multiple ASes which coordinate with each other to route traffic. The top-k ASes means that there may be a few malicious entities from where the attacks are being launched.

For validation, the attacks detected may be correlated with reports, or tickets, of outbound incidents. Additionally, these detected attacks may be correlated with traffic history to identify the attack pattern. Further, time-based correlation, e.g., dynamic time warping, can be performed to identify attacks that target multiple VIPs simultaneously. Similarly, alerts from commercial security solutions may be used for validation by correlating the security solution's alerts with historical traffic. The data can be analyzed to determine thresholds, packet signatures, and so on, for alerted attacks.

Advantageously, implementations provide systematic analyses for a range of attacks in the cloud network, in comparison to present techniques. The output of these analyses can be used for both tactical and strategic decisions, e.g., where to tune the thresholds, the selection of network traffic features, and whether to deploy a scale-out, attack detection service as described herein.

FIG. 1 is a block diagram of an example cloud provider system 100 for analyzing datacenter attacks, according to implementations described herein. In the system 100, a data center architecture 102 includes border routers 106, load balancers 108, and end hosts 110. Additionally, a security appliance 112 is deployed at the edge of the architecture 102. The ingress arrows show the path of data packets inbound to the data center, and the egress arrows show the path of outbound data packets. In implementations, the system 100 includes multiple geographically replicated datacenter architectures 102 connected to each other and to the Internet 104 via the border routers 106. The system 100 hosts multiple services and each hosted service is assigned a public virtual IP (VIP) address. Herein, the terms, “VIP” and “service,” are used interchangeably. User requests to the services are typically load balanced across the end host 110, which includes a pool of servers that are assigned direct IP (DIP) addresses for intra-datacenter routing. Incoming traffic first traverses the border routers 106, then security appliances 112 for detecting ongoing datacenter attacks, and may attempt to mitigate any detected attacks. Security appliances 112 may include firewalls, DDoS protection appliances and intrusion detection systems. Incoming traffic then goes to the load balancers 108 that distribute traffic across service DIPs.

Some organizations use enterprise-hosted services, which allows for more direct control over services than what would be possible with a cloud provider. Although enterprise servers may also be targets of cyber attacks, two aspects of cloud infrastructure make it more useful than enterprise architecture for analyzing and detecting cloud attacks. First, compared to enterprise-hosted services, cloud services have greater diversity and scale. One example cloud provider hosts more than 10,000 services that include web storefronts, media streaming, mobile apps, storage, backup, and large online marketplaces. Unfortunately, this also means that a single, well-executed attack can cause more direct and collateral damage than individual attacks on enterprise-hosted services. While such a large service diversity allows observing a wide variety of inbound attacks, this diversity also makes it challenginging to distinguish attacks from legitimate traffic. This may be due to the services' likely generation of a variety of possible traffic patterns during normal operation. Second, attackers can abuse the cloud resources to launch outbound attacks. For instance, brute-force attacks (e.g., password guessing) can be launched to compromise vulnerable VMs and gain bot-like control of infected VMs. Compromised VMs may be used for a variety of adversarial purposes such as click fraud, unlawful streaming of protected content, illegally mining electronic currencies, sending SPAM, propagating malware, launching bandwidth-flooding DoS attacks, and so on. To fight bandwidth-flooding attacks, cloud providers prevent IP spoofing and typically cap outgoing bandwidth per VM, but not in aggregate across a tenant's instances.

The edge routers 106, load balancers 108, end hosts 110, and security appliance 112, each represent different layers of the data center's network topology Implementations of the claimed subject matter use data collected at the different layers to detect attacks in real time or offline. Real-time computing relates to software systems subject to a time constraint for a response to an event, for example, a data center attack. Real-time software provides the response within the time constraints, typically in the order of milliseconds and smaller. For example, the edge routers 106 may sample inbound and outbound packets in intervals as brief as 1 minute. The sampling may be aggregated for reporting traffic volume 114 between nodes. Each layer provides some level of analysis, including analysis in the load balancer 108, and analysis in the end hosts 110. This data may be input to an attack detection engine 120, hosted on one or more commodity servers/VMs 118. The engine 116 generates attack notifications 120 when a datacenter network attack is detected. Offline computing typically refers to systems that process large volumes of data without strict time constraints, such as in real-time systems.

The network traffic data 114 aggregates the sampled number of packets per flow (sampled uniformly at the rate of 1 in 4096) over a one minute window. An example implementation filters network traffic data 114 based on the list of VIPs (matching source or DIP fields in the network traffic data 114) of the hosted services. The results validate these techniques, in comparing attack notifications 120 against a public list of TDS nodes, incident reports written by operators, and alerts from a DDoS-mitigation appliance, i.e., a security appliance 112. A large scalable data storage system may be used to analyze this network traffic data 114, using a programming framework that provides for the filtering of data using various filters, defined according to a business interest, for example. Validation involves using a high-level programming language such as C# and SQL-like queries to aggregate the data by VIP, and then perform the analysis described below. In this way, implementations analyze more than 25,000 machines hours worth of computation in less than a day. To study attack diversity and prevalence, four techniques are used on the network traffic data 114 for each time window. In each method, traffic aggregates destined to a VIP (for inbound attacks), or from a VIP (for outbound attacks) are analyzed.

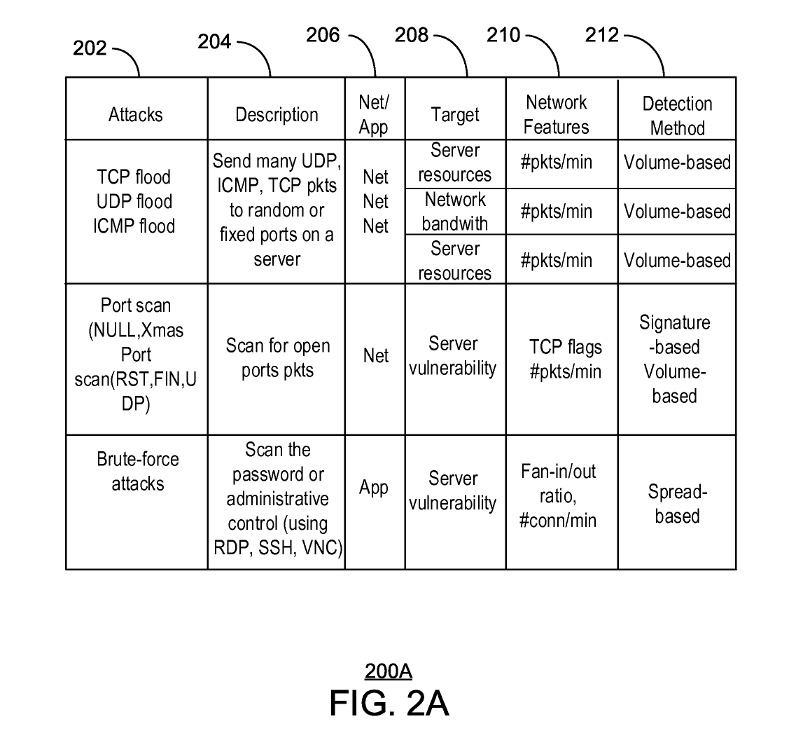

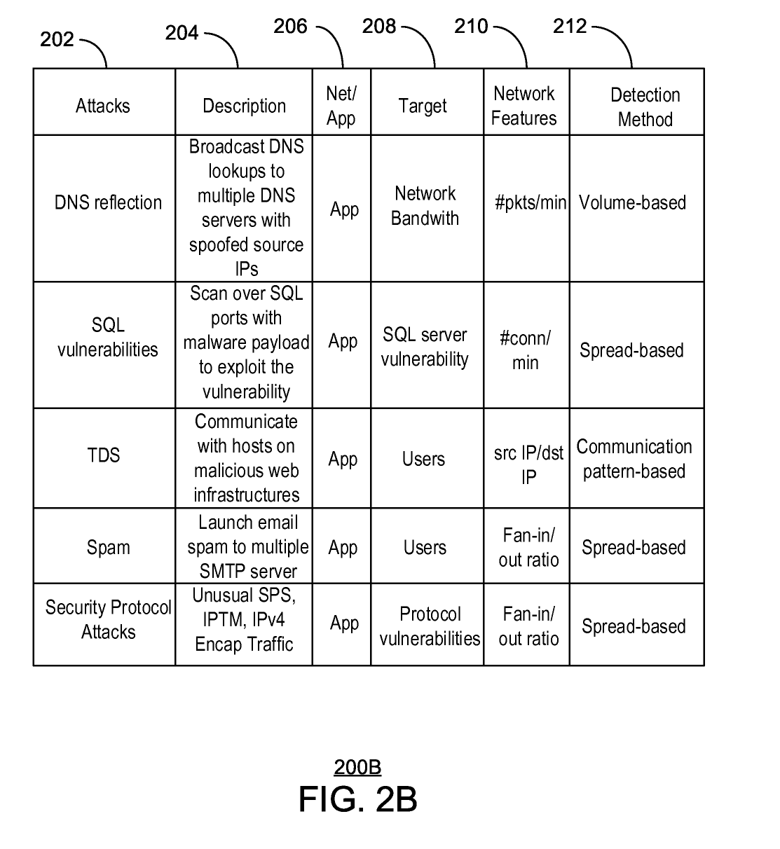

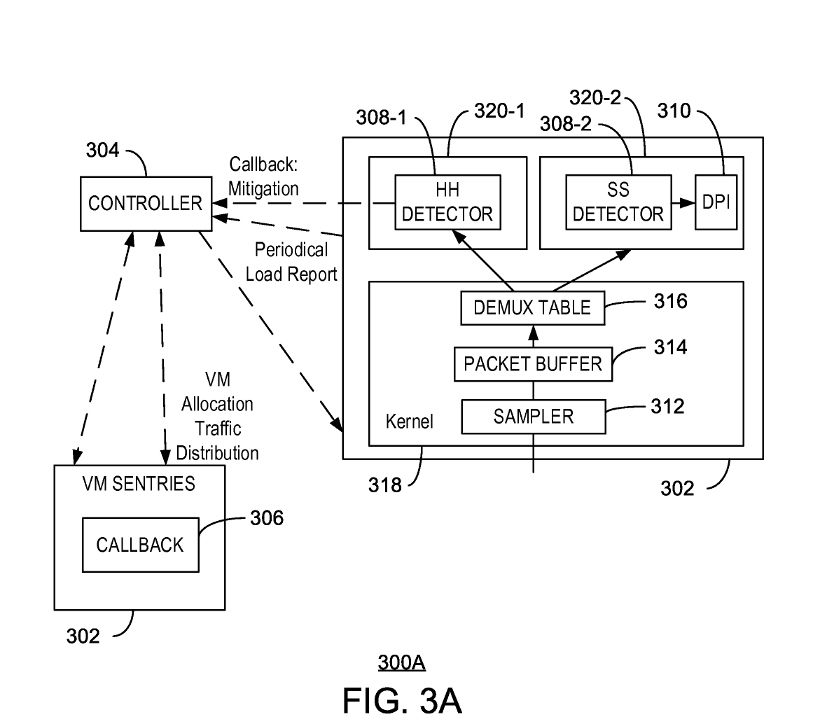

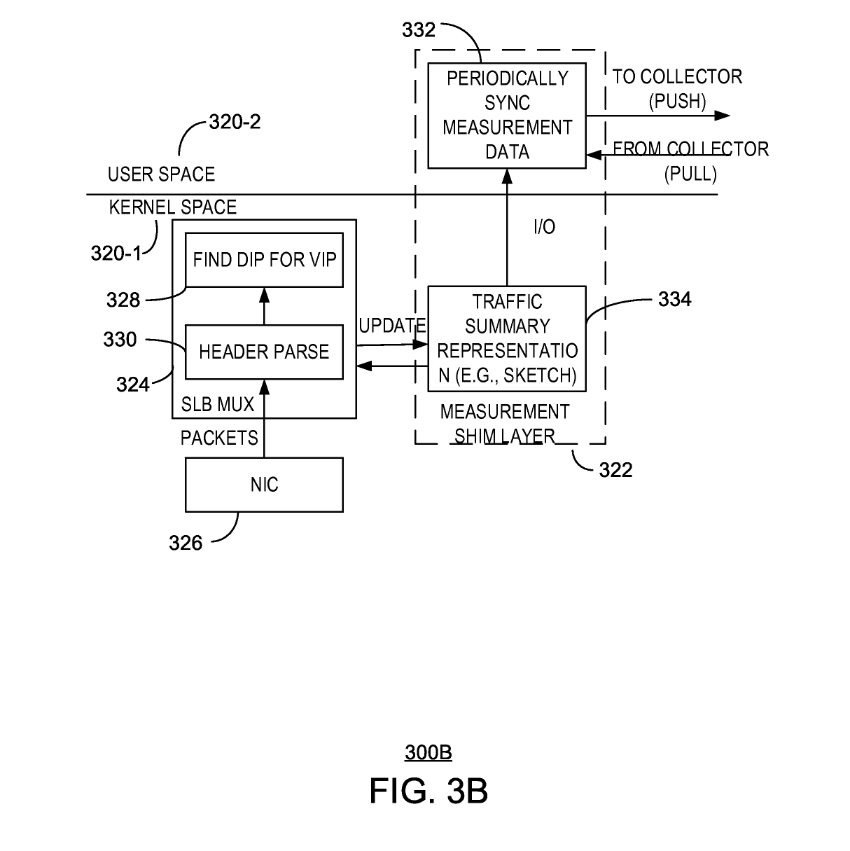

FIGS. 2A-3B are tables 200A, 200B summarizing network features of datacenter attacks, according to implementations described herein. For each attack type 202, the tables 200A, 200B include a description 204, network- or application-based attack indicator 206, target 208, network features 210, and detection methods 212. In this way, the tables 200A, 200B summarize the network feature of attacks detected and the techniques used to detect these attacks. Volume-based (volumetric) detection includes volume- and relative-threshold-based techniques. Many popular DoS attacks try to exhaust server or infrastructure resources (e.g., memory, bandwidth) by sending a large volume of traffic via a specific protocol. The volumetric attacks include TCP SYN and UDP floods, port scans, brute-force attacks for password scans, DNS reflection attacks, and attacks that attempt to exploit vulnerabilities in specific protocols. In one implementation, the attack detection engine 116 detects such attacks using sequential change point detection. During each measurement interval (1 minute for the example network traffic data), the attack detection engine 116 determines an exponential weighted moving average (EWMA) smoothed estimate of the traffic volume (e.g., bytes, packets) to a VIP. The engine 120 uses the EWMA to track a traffic timeline for each VIP. The formula for the EWMA, for a given time, t, for the estimated value y_est of a signal is given in Equation 1 as a function of the traffic signal's value y(t) at current time t, and its historical values y(t−1), y(t−2), and so on:

y_est(t)=EWMA(y(t),y(t−1), . . . ) (1)

Accordingly, a traffic anomaly, i.e., a potential data center attack, may be detected if Equation 2 is true for a specific delta where delta denotes a relative threshold:

y(t+1)>delta*y_est(t),(e.g., set delta=2) (2)

In some implementations, another hard limit (or absolute threshold) may be used to identify an extreme anomaly, such as 200 packets per minute, i.e., 0.45 million bytes per second of sampled flow volume for a packet size of 1500 bytes. Typically, static thresholds may be set at the 95^{th} percentile of TCP, UDP protocol traffic. In contrast, implementations use an empirical, data-driven approach, where, e.g., 99th percentile of traffic and EWMA smoothing is used to determine a dynamic threshold. The error between the EWMA-smoothed estimate and the actual traffic volume to a VIP is also determined during each measurement interval. The engine 116 detects an attack if the total error over a moving window (e.g., the past 10 minutes) for a VIP exceeds a relative threshold. In this way, the engine 116 detects both (a) heavy hitter flows by volume, and (b) spikes above relative-thresholds. These may be detected at different time granularities, e.g., 5 minutes, 1 hour, and so on. In contrast to current techniques for volume thresholds, implementations may set a relative threshold, such that the detected heavy hitters lie above the 99th percentile of the network traffic data distribution.

Many services (e.g., DNS, RDP, SSH), have a single source that typically connects to only a few DIPS on the end host 110 during normal operation. Accordingly, spread-based detection treats a source communicating with a large number of distinct servers as a potential attack. To identify this potential attack behavior, network traffic data 114 is used to compute the fan-in (number of distinct source IPs) for the services' inbound traffic, and the fan-out (number of distinct destination IPs) for the services' outbound traffic. The sequential change point detection method described above is used to detect spread-based attacks. Similar to the volumetric techniques, the threshold for the change point detection may be set to ensure that attacks lie in the 99th percentile of the corresponding distribution. However, either technique may specify different percentiles, based on the traffic observed at a data center, for example, by the operators.

TCP flag signatures are also used to detect cyber-attacks. Although packet payloads may not be logged in the example network traffic data 114, implementations may detect some attacks by examining the TCP flag signatures. Port scanning and stack fingerprinting tools use TCP flag settings that violate protocol specifications (and as such, are not used by normal traffic). For example, the TCP NULL port scan sends TCP packets without any TCP flags, and the TCP Xmas port scan sends TCP packets with FIN, PSH, and URG flags (See tables 200A, 200B). In the example network traffic data 114, if a VIP receives one packet with an illegal TCP flag configuration during a measurement interval, that interval is marked as an attack interval. The network traffic data 114 is sampled, so even a single logged packet may indicate a larger number of packets with illegal TCP flag configurations than just the one sampled.

The communication patterns with known compromised server nodes are also used to detect cyber-attacks. Traffic Distribution Systems (TDSs) typically facilitate traffic flows to deliver malicious content on the Internet. These nodes have been observed to be active for months and even years, are hardly reachable (e.g., web links) from legitimate sources, and seem to be closely related to malicious hosts with a high reputation in Darknet (76% of considered malicious paths). Further, 97.75% of dedicated TDS do not receive any traffic from legitimate resources. Therefore, any communication with these nodes likely indicates a malicious or compromised service. Implementations measure TDS contact with VIPs within the datacenter architecture 102 by using a blacklist of IP addresses for TDS nodes. As with signature-based attacks, any measurement interval where a VIP receives or sends even one packet to or from a TDS node is marked as an attack interval because the network traffic data 114 is sampled. Thus, just one packet during a one-minute measurement interval in the exemplary traces may indicate a few thousand packets from TDS nodes.

Implementations may also count the number of unique attacks. Because network traffic data 114 samples flows at a very low rate, these estimates of fan-in and fan-out counts may differ from the true values. To avoid overcounting the number of attacks, multiple attack intervals are grouped into a single attack, where the last attack interval is followed by TI inactive (i.e., no attack) intervals. However, selecting an appropriate TI threshold is challenging because if too small, a single attack may be split into multiple smaller ones. On the other hand, if it is too large, unrelated attacks may be combined together. Further, a global TI value would be inaccurate as different attacks may exhibit different activity patterns. In one implementation, the counts of the number of attacks for each attack type, is plotted as a function of TI, the value corresponding to the ‘knee’ of the distribution is selected for the threshold. In this way, the threshold shows occurs when TI beyond this point does not change the relative number of attacks.

Given that network traffic data 114 is sampled, some low-rate attacks (e.g., low-rate DoS, shrew), or attacks that occur during a short time window may be missed. Additionally, implementations may underestimate the characteristics of some attacks, such as traffic volume and duration. For these reasons, the results are interpreted as a conservative estimate of the traffic characteristics (e.g., volume and impact) of these attacks.

### Cloud Attack Characterization

The detections may be performed using three complementary data sources. This characterization is useful to understand the scale, diversity, and variability of network traffic in today's clouds, and also justifies the selection of attacks to identify in one implementation.

In normal operation, a few instances of specific TCP control traffic is expected, such as TCP RST and TCP FIN packets. However, the VIP-rate for this type of control traffic may be high in comparison to ICMP traffic. Further, a high incidence of outbound TCP RST traffic may be caused by VM instances responding to unexpected packets (e.g., scanning), while that of the incoming RSTs may be due to targeted attacks e.g., backscatter traffic. Moreover, some other types of packets (e.g., TCP NULL) should not be seen in normal traffic, but if the 99th percentile VIP-rate for this control traffic is over 1000 packets/min in a sample, as indicated in tables 200A, 200B, port-scan detection may be used.

Traffic across protocols is fat-tailed. In other words, network protocols exhibit differences between tail and median traffic rate. There are typically more UDP inbound packets than outbound at the tail caused by either attacks (e.g., UDP flood, DNS reflection) or misuse of traffic during application outages (e.g., VoIP services generate small-size UDP packet floods during churn). Also, for most protocols, the tail of the inbound distribution is longer than that of outbound, with exceptions including RDP and VNC traffic (indicating the presence of outbound attacks originating from the cloud), motivating their analysis in tables 200A, 200B. Additionally, RDP (Remote Desktop Protocol) traffic has a heavy tail inbound which indicates the cloud receives inbound RDP attacks. An RDP connection is interactive typically between a user to another computer or to a small number of computers. Thus, a high RDP traffic rate likely indicates an attack e.g., password guess. Note that implementations may underestimate inbound RDP traffic because the cloud provider may use a random port (instead of the standard port 2389) to protect against brute-force scans. Third, DNS traffic has over 22 times more inbound traffic than outbound in the 99th percentile. This is likely an indication of a DNS reflection attack because the cloud has its own DNS servers to answer queries from hosted services.

Inbound and outbound traffic differ at the tail for some protocols. The cloud receives more inbound UDP, DNS, ICMP, TCP SYN, TCP RST, TCP NULL, but generates more outbound RDP traffic. Inbound attacks are dominated by TDS (26.6%), followed by port scan (22.0%), brute force (16.0%) and the flood attacks. The outbound attacks are dominated by flood attacks (SYN 19.3%, UDP 20.4%), brute force attacks (21.4%) and SQL vulnerability (19.6% in May). From May to December, there is a decrease of flood attacks, but an increase in brute-force attacks. These numbers represent a qualitative difference between inbound and outbound attacks. Cloud services are usually targeted via TDS nodes, brute force attacks, and port scans. After they are compromised, the cloud is being used to deliver malicious content and launch flooding attacks to external sites. In attack prevalence, inbound attacks are qualitatively different in frequency than outbound attacks.

A characterization of attack intensity is based on duration, inter-arrival time, throughput, and ramp-up rates for high-volume attacks, including TCP SYN flood, UDP flood, and ICMP flood. This does not include estimated onset for low-volume attacks due to sampling. Nearly 20% of outbound attacks have an inter-arrival time less than 10 minutes, while only about 5%-10% of inbound attacks have inter-arrivals times less than 10 minutes. Further, inbound traffic for the top 20% of the shortest inter-arrival time predominantly use HTTP port 80. In some cases, the SLB facing these attacks exhausts its CPU causing collateral damage by dropping packets for other services. There were also periodic attacks, with a periodicity of about 30 minutes. Most flooding attacks (TCP, UDP, and ICMP) had a short duration, but a few of them last several hours or more. Outbound attacks have smaller inter-arrival times than inbound attacks.

The median throughput of inbound UDP flood attacks is about 4.5 times that of TCP SYN Floods. Further, inbound DNS reflection attacks exhibit high throughput, even though the prevalence of these attacks is relatively small. In the outbound direction, brute force attacks exhibit noticeably higher throughputs than other attacks. SYN attacks have higher throughput in the inbound direction than in the outbound, while several attacks such as port-scans and SQL have comparable throughputs in both directions. Throughputs vary in inbound and outbound directions by 3 to 4 orders of magnitude. UDP flood throughput dominates, but there are distinct differences in throughput for some other protocols in both directions.

The ramp-up time for attacks may be considered to include the starting time of an attack spike to the time the volume grows to at least 90% of its highest packet rates in the instance. Typically, inbound attacks get to full strength relatively slowly, when compared with outbound. For example, 80% of the inbound ramp-up times are twice that for outbound, and nearly 50% of outbound UDP floods and 85% of outbound SYN floods ramp-up in less than a minute. This is because the incoming traffic may experience rate-limiting or bandwidth bottlenecks before arriving at the edge of the cloud, and incoming DDoS traffic may ramp-up slowly because their sources are not synchronized. In contrast, cloud infrastructure provides high bandwidth capacity (only limiting per-VM bandwidth, but not in aggregate across a tenant) for outbound attacks to build up quickly, indicating that cloud providers should be proactive in eliminating attacks from compromised services. The median ramp up time for inbound attacks may be 2-3 mins, but 50% of outbound attacks ramp up within a minute. Accordingly, the attack detection engine 116 may react within 1-3 minutes.

Spatio-temporal features of attacks represent how attacks are distributed across address, port spaces and geographically, and show correlations between attacks. The distribution of source IP addresses for inbound attacks indicates the distribution of TCP SYN attacks is uniform across the entire address range, indicating that most of these attacks used spoofed IP addresses. Most other attacks are also uniformly distributed, with two exceptions being port-scans (where about 40% of the source addresses come from a single IP address), and Spam, which originates from a relatively small number of source IP addresses (this is consistent with earlier findings using Internet content traces). This suggests that source address blacklisting is an effective mitigation technique for Spam, but not other attack types.

Two patterns in port usage by inbound TCP SYN attacks show they typically use random source ports and fixed destination ports. This may be because the cloud only opens a few service ports that attackers can leverage, and most attacks target well-known services hosted in the cloud, e.g., HTTP, DNS, SSH. Additionally, some attacks round-robin the destination ports, but keep the source port fixed. Seen at border routers 106, these attacks are more likely to be blocked by security appliances 112 inside the cloud network before they reach services. Common ports used in TCP SYN and UDP flood attacks show less port diversity in inbound traffic, which may be because cloud services only permit traffic to a few designated common services (HTTP, DNS, SSH, etc.).

In one implementation, of the top 30 VIPs by traffic volume for TCP SYN, UDP and ICMP traffic, 13 are victims of all the three types of attacks, and 10 are victims of at least two types. Further, several instances of correlated inbound and outbound attacks were identified. For example, a VM first is targeted by inbound RDP brute force attacks, and then starts to send outbound UDP floods, indicating a compromised VM.

In another implementation, instances of correlated attacks exist across time, VIPs, and between inbound and outbound directions. The attack classifications may be validated using three different sources of data from the cloud provider: a system that analyzes incident reports to detect attacks, a hardware-based anomaly detector, and a collection of honeypots inside the cloud provider. Even though these data sources are available, attacks may also be characterized using network traffic data 114 data for the following reasons. Incident reports may be available for outbound attacks. Typically, these reports are filed by external sites affected by outbound attacks. A hardware-based anomaly detector may capture volume-based attacks, but is typically operated by a third-party vendor. These vendors typically provide only 1-week's history of attacks. Additionally, the honeypots may only capture spread-based attacks.

Current approaches for both inbound and outbound attacks have limitations. Currently, to detect incoming attacks, cloud operators usually adopt a defense-in-depth approach by deploying (a) commercial hardware boxes (e.g., Firewalls, IDS, DDoS-protection appliances) at the network level, and (b) proprietary software (e.g., Host-based IDS, anti-malware) at the host level. These network boxes analyze inbound traffic to protect against a variety of well-known attacks such as TCP SYN, TCP NULL, UDP, and fragment misuse. To block unwanted traffic, operators typically use a combination of mitigation mechanisms such as, ACLs, blacklists or whitelists, rate limiters, or traffic redirection to scrubbers for deep packet inspection (DPI), i.e., malware detection. Other middle boxes, such as load balancers 108, aid detection by dropping traffic destined to blocked ports. To protect against application-level attacks, tenants install end host-based solutions for attack detection on their VMs. These solutions periodically download the latest threat signatures and scan the deployed instance for any compromises. Diagnostic information, such as logs and antimalware events, are also typically logged for post-mortem analysis. Access control rules can be set up to rate limit or block the ports that the VMs are not supposed to use. Finally, network security devices 112 can be configured to mitigate outbound anomalies similar to inbound attacks. However, while many of these approaches are relevant to cloud defense (such as end-host filtering, and hypervisor controls), commercial hardware security appliances are inadequate for deployment at the cloud scale because of their cost, lack of flexibility, and the risk of collateral damage. These hardware boxes introduce unfavorable cost versus capacity tradeoffs. However, these boxes can only handle up to tens of gigabytes of traffic, and risk failure under both network-layer and application-layer DDoS attacks. Thus, to handle traffic volume at cloud scale and increase increasingly high-volume DoS attacks (e.g., 300 Gbps+ [45]), this approach would incur significant costs. Further, these devices are deployed in a redundant manner, further increasing procurement and operational costs.

Additionally, since these devices run proprietary software, they limit how operators can configure them to handle the increasing diversity of attacks. Given the lack of rich pro-grammable interfaces, operators are forced to specify and manage a large number of policies themselves for controlling traffic, e.g., setting thresholds for different protocols, ports, cluster, VIPs at different time granularities. Further, they have limited effectiveness against increasingly sophisticated attacks, such as zero-day attacks. Additionally, these third-party devices may not be kept up to date with OS, firmware and builds, which increases the risk of reduced effectiveness against attacks.

In contrast to expensive hardware appliances, implementations leverage the principles of cloud computing: elastic scaling of resources on demand, and software-defined networks (programmability of multiple network layers) to introduce a new paradigm of detection-as-a-service and mitigation-as-a-service. Such implementations have the following capabilities: 1. Scaling to match datacenter traffic capacity at the order of hundreds of gigabits per second. The detection and mitigation as services autoscale to enable agility and cost-effectiveness; 2. Programmability to handle new and diverse types of network-based attacks, and flexibility to allow tenants or operators to configure policies specific to the traffic patterns and attack characteristics; 3. Fast and accurate detection and mitigation for both (a) short-lived attacks lasting a few minutes and having small inter-arrival times, and (b) long-lived sustained attacks lasting more than several hours; once the attack subsides, the mitigation is reverted to avoid blocking legitimate traffic.

FIG. 3A is a block diagram of an attack detection system 300, according to implementations described herein. The attack detection system 300 may be a distributed architecture using an SDN-like framework. The system 300 includes a set of VM instances that analyze traffic for attack detection (VMSentries 302), and an auto-scale controller 304 that (a) does scale-out/in of VM instances to avoid overloading, (b) manages routing to traffic flows to them, and (c) dynamically instantiates anomaly detector and mitigation modules on them. To enable applications and operators to flexibly specify sampling, attack detection, and attack mitigation strategies, the system 300 may expose these functionalities through RESTful APIs. Representational state transfer (REST) is one way to perform database-like functionality (create, read, update, and delete) on an Internet server.

The role of a VMSentry 302 is to passively collect ongoing traffic via sampling, analyze it via detection modules, and prevent unauthorized traffic as configured by the SDN controller. For each VMSentry 302, the control application instantiates (1) a heavy-hitter (HH) detector 308-1 for TCP SYN/UDP floods, super-spreader (SS) 308-2 for DNS reflection), (2) attach a sampler 312 (e.g., flow-based, packet-based, sample-and-hold), and set its configurable sampling rate, (3) provide a callback URI 306, and (4) install it on that VM. When the detector instances 308-1, 308-2 detect an on-going attack, they invoke the provided callback URI 306. The callback can then decide to specify a mitigation strategy in an application-specific manner. For instance, the callback can set up rules for access control, rate-limit or redirect anomalous traffic to scrubber devices for an in-depth analysis. Setting up mitigator instances is similar to that of detectors—the application specifies a mitigator action (e.g., redirect, scrub, mirror, allow, deny) and specifies the flow (either through a standard 5-tuple or <VIP, protocol> pair) along with a callback URI 306.

In this way, the system 300 separates mechanism from policy by partitioning VMSentry functionalities between the kernel space 320-1 and user space 320-2: packet sampling is done in the kernel space 320-1 for performance and efficiency, and the detection and mitigation policies reside in the user space 320-2 to ensure flexibility and adaptation at run-time. This separation allows multi-stage attack detection and mitigation, e.g., traffic from source IPs sending a TCP SYN attack can be forwarded for deep packet inspection. By co-locating detectors and mitigators on the same VM instance, the critical overheads of traffic redirection are reduced, and the caches may be leveraged to store packet content. Further, this approach avoids the controller overheads of managing different types of VMSentries 302.

The specification of the granularity at which network traffic data is collected impacts limited computing and memory capacity in VM instances. While using the five-tuple flow identifier allows flexibility to specify detection and mitigation at a fine granularity, it risks high resource overheads, missing attacks at the aggregate level (e.g., VIP) or treating correlated attacks as independent ones. In the cloud setup, since traffic flows can be logically partitioned by VIPs, the system 300 flows using <VIP, protocol> pairs. This enables the system 300 to (a) efficiently manage state for a large number of flows at each VMSentry 302, and (b) design customized attack detection solutions for individual VIPs. In some implementations, the traffic flows for a <VIP, protocol> pair can be spread across VM instances similar in spirit to SLB.

The controller 304 collects the load information across instances of every measurement interval. A new allocation of traffic distribution across existing VMs and scale-out/in VM instances may be re-computed at various times during normal operation. The controller 304 also installs routing rules to redirect network traffic. In the cloud environment, traffic patterns destined to a VMSentry 302 may increase due to a higher traffic rate of existing flows (e.g., volume-based attacks), or as a result of the setup of new flows (e.g., due to tenant deployment). Thus, it is useful to avoid overload of VMSentry instances, as overload risks impacting accuracy and effectiveness of attack detection and mitigation. To address this issue, the controller 304 monitors load at each instance and dynamically re-allocates traffic across the existing and possibly newly-instantiated VMs.

The CPU may be used as the VM load metric because CPU utilization typically correlates to traffic rate. The CPU usage is modeled as a function of the traffic volume for different anomaly detection/mitigation techniques to set the maximum and minimum load threshold. To redistribute traffic, a bin-packing problem is formulated, which takes the top-k <VIP, protocol> tuples by traffic rate as input from the overloaded VMs, and uses a first-fit decreasing algorithm that allocates traffic to the other VMs while minimizing the migrated traffic. If the problem is infeasible, it allocates new VMS entry instances so that no instance is overloaded. Similarly, for scale-in, all VMs whose load falls below the minimum threshold become candidates for standby or being shut down. The VMs selected to be taken out of operation stop accepting new flows and transition to inactive state once incoming traffic ceases. It is noted that other traffic redistribution and auto-scaling approaches can be applied in the system 300. Further, many attack detection/mitigations tasks are state independent. For example, to detect the heavy hitters of traffic to a VIP, the traffic volume is tracked for the most recent intervals. This simplifies traffic redistribution as it avoids transferring potentially large measurement state of transitioned flows. For those measurement tasks that do use state transitions, a constraint may be added for the traffic distribution algorithm to avoid moving their traffic.

To redistribute traffic, the controller 304 changes routing entries at the upstream switches/routers to redirect traffic. To quickly transition an attacked service to a stable state during churn, the system 300 maintains a standby resource pool of VMs which are in active mode and can take the load. In contrast to current systems that sample data traffic, the attack detection engine 116 monitors live packet streams without sampling through use of a shim layer. The shim layer is described with respect to FIG. 3B.

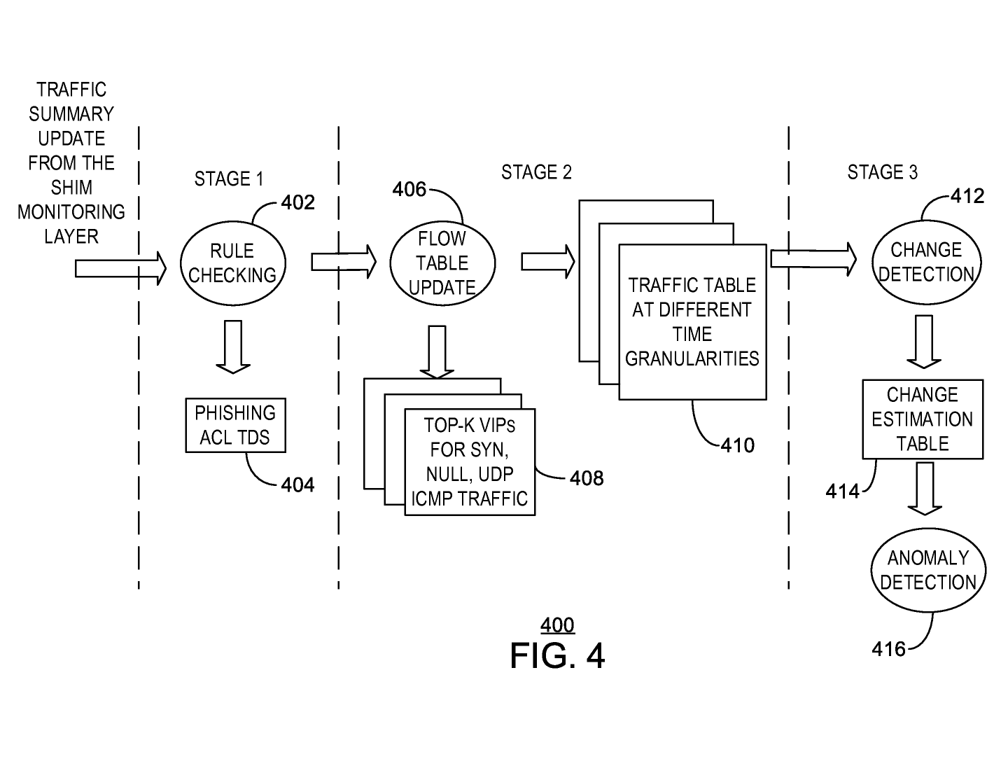

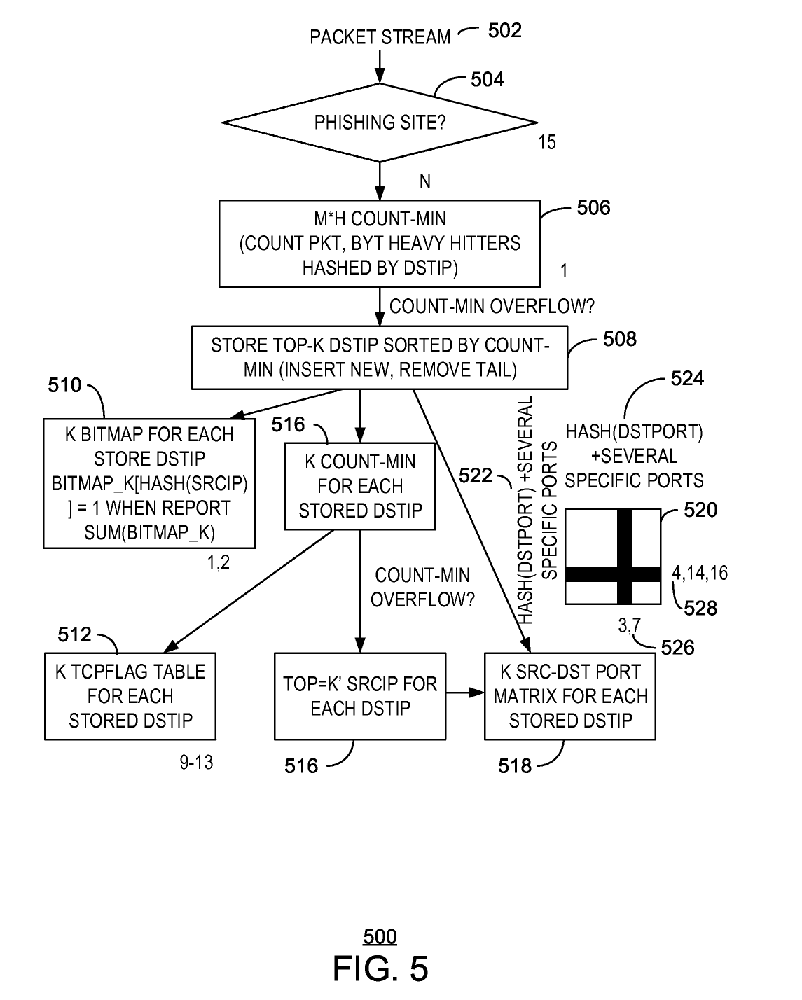

FIG. 3B is a block diagram of an attack detection system 300, according to implementations described herein. The system 300 includes a kernel space 320-1 and user space 320-2. The spaces 320-1, 320-2 are operating system environments with different authorities for resources on the system 300. The user space 320-2 is where VIPs execute, with typical user permissions to storage, and other resources. The kernel space 320-1 is where the operating system executes, with authority to access all immediate system resources. Additionally, in the kernel space 320-1 data packets pass from a communications device, such as a network interface connector 326 to a software load balancer (SLB) mux 324. Alternatively, a hardware-based load balancer may be used. The mux 324 may be hosted on a virtual machine or a server, and includes a header parse program 330 and a destination IP (DIP) program 328. The header parse program 310 parses the header of each data packet. Typically, this program 310 looks at the flow-level fields, such as source IP, source port, destination IP, destination port and protocol including flags to determine how to process that packet. Additionally, the DIP program 328 determines the DIP for the VIP receiving the packet. A shim layer 322 includes a program 332 that runs in the user space 320-2, and retrieves data from a traffic summary representation 334 in the kernel space 320-1. The program 332 periodically syncs measurement data between the traffic summary representation 334 and a collector. Using the synchronized measurement data, the attack detection engine 116 detects cyberattacks in a multi-stage pipeline, described with respect to FIGS. 4 and 5.

FIG. 4 is a block diagram of an attack detection pipeline 400, according to implementations described herein. The pipeline 400 inputs the traffic summary representation 334 for the shim layer 322 to Stage 1. In Stage 1, rule checking 402 is performed to identify blacklisted sites, such as phishing sites. Implementations may use rules for rule checking 402. In implementations, ACL filtering is performed against the source and destination IP addresses to identify potential phishing attacks.

In Stage 2, a flow table update 406 is performed. The flow table update 406 may identify the top-K VIPs for SYN, NULL, UDP, and ICMP traffic 408. In implementations, K represents a pre-determined number for identifying potential attacks. The flow table update 406 also generates traffic tables 410, which represent data traffic statistics recorded at different time granularities. Representing this data at different time granularities enables the attack detection engine 116 to detect transient, short-duration attacks as well as attaches that are persistent, or of long-duration.

In Stage 3, change detection 412 is performed based on the traffic tables 410, producing a change estimation table 414. The traffic tables 410 are used to record the traffic changes. The traffic estimation table tracks the smoothed traffic dynamics, and predicts future traffic changes based on current and historical traffic information. The change estimation table 414 is used to identify traffic anomalies based on a threshold. The change estimation table 414 is used for anomaly detection 416. If an anomaly is detected, an attack notification 120 may be generated.

FIG. 5 is a process flow diagram of a method 500 for analyzing datacenter attacks, according to implementations described herein. The method 500 processes each packet in a packet steam 502. At block 504, it is determined whether the data packet originates from a phishing site. If so, the packet is filtered out of the packet stream. If not, control flows to block 506, where Blocks 506-918 reference sketch-based hash tables that count traffic using different patterns and granularities. At block 506, heavy flow is tracked on different destination IPs. At block 508, the top-k destination IPs are determined. At block 510, the source IPs for the top-k destination IPs are determined. At blocks 512, 516, 518 the top-k TCP flags, source IP, and source destination ports for the destination IPs determined at block 508.

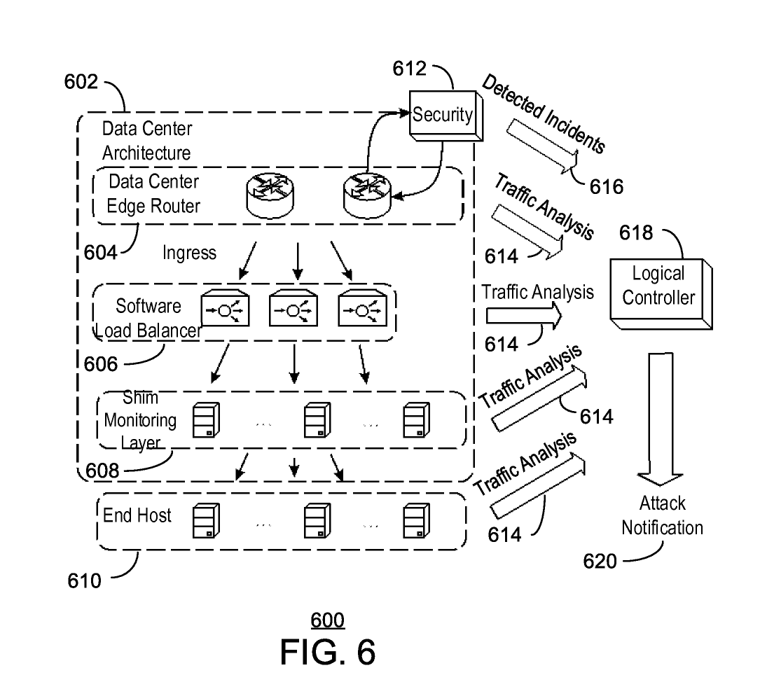

FIG. 6 is a block diagram of an example system 600 for detecting datacenter attacks, according to implementations described herein. The system 600 includes datacenter architecture 602. The data center architecture 602 includes edge routers 604, load balancers 606, a shim monitoring layer 608, end hosts 610, and a security appliance 612. Traffic analysis 614 from each layer of the data center architecture is input, along with detected incidents 616 generated by the security appliance, to a logical controller 618. The logical controller 618 generates attack notifications 620 by performing attack detection according to the techniques described herein.

The controller 618 can be deployed as either an in-band or an out-of-band solution. While the out-of-band solution avoids taking resources (e.g., switches, load balancers 606), there is extra overhead for duplicating (e.g., port mirroring) the traffic to the detection and mitigation service. In comparison, the in-band solution uses faster scale-out to avoid affecting the data path and to ensure packet forwarding at line speed. While the controller 618 is designed to overcome limitations in commercial appliances, these can complement the system 600. For example, a scrubbing layer in switches may be used reduce the traffic to the service or use the controller 618 to decide when to forward packets to hardware-based anomaly detection boxes for deep packet inspection.

An example implementation includes three servers and one switch interconnected by 10 Gbps links. The machines include 32 cores and 32 GB memory, acting as the traffic generator, and another machine with 48 cores and 32 GB memory as the traffic receiver, each with one 10GE NIC connecting to the 10GE physical switch. The controller runs on a machine with 2 CPU cores and 2 GB DRAM. Additionally, a hypervisor on the receiver machine hosts a pool of VMs. Each VM has 1 core and 512 MB memory, and runs a lightweight operating system. Heavy hitter and super spreader detection are implemented in the user space 320-2 with packet and flow sampling in the kernel 320-1. Synthesized traffic was generated for 100K distinct destination VIPs using the CDF of number of TCP packets destinated to specific VIPs. The input throughput is varied by replaying the traffic trace at different rates. Packet sampling is performed in the kernel 318, and a set of traffic counters keyed on <VIP, protocol> tuples is also maintained, which takes around 110 MB. Each VM reports a traffic summary and the top-K heavyhitters to the controller every second, and the controller summarizes and pick top-K heavyhitter among all the VMs every 5 seconds. The 5 second time period enables investigating the short-term variance of in measurement performance. Accuracy is defined as the percentage of heavyhitter VIPs the system identified which are also located in the top-K list in the ground truth. In one implementation, K was set to 100, which defines heavy-hitters as corresponding to the 99.9 percentile of 100K VIPs. A new VM instance can be instantiated in 14 seconds, and suspended within 15 seconds. This speed can be further improved with light-weight VMs Implementations can dynamically control on L2 forwarding at per-VIP granularity, and the on-demand traffic redirection incurs sub-millisecond latency.

The accuracy of the controller 618 decreases rapidly as the system drops lots of packets. In other words, as more VMs get started, the accuracy gradually recovers and the system throughput increases to accommodate the attack traffic. In one experiment, the controller 618 scaled-out to 10 VMs. With the increasing number of active VMs, the controller 618 takes around 55 seconds to recover its measurement accuracy, and 100 seconds to accommodate the 9 Gbps traffic burst.

Additionally, the controller 618 scales-out to accommodate different volumes of attacks. In the example implementation, the packet sampling rate in each VM is set at 1%. Starting with 1 Gbps traffic and 2 VMs, then increasing the attack traffic volume from 0 to 9 Gbps. The accuracy for larger attack durations is higher than that for shorter duration. This is because the accuracy is affected by the packet drops during VM initiation. Therefore, if the attacks last longer, the impact of the initiation delay becomes smaller. With a standby VM, the controller 618 achieves better accuracy. This is because the standby VM can absorb a sudden traffic burst, and instantiate a new VM ahead before the traffic approaches system capacity.

The accuracy increases slightly for smaller attack volumes. At low volumes, because traffic is sampled before detecting heavy-hitters, sampling errors cause accuracy to decrease. With increasing volumes, accuracy increases because heavy-hitters are correctly identified by sampling. With a further increase in traffic volume, accuracy degrades slowly: in this regime, the instantiation delays for scale-out result in dropped packets and missed detections. This drop in accuracy is continuous, and has to do with a limitation of the hypervisor. At high traffic volumes, many VMs are be instantiated concurrently, but the example hypervisor instantiates VMs sequentially. This may be mitigated by parallelizing VM startup in hypervisors, and by using lightweight VMs. The example implementation achieves a high accuracy with 1% sample rate even at high volumes, and the accuracy increases when traffic is sampled at 10%.

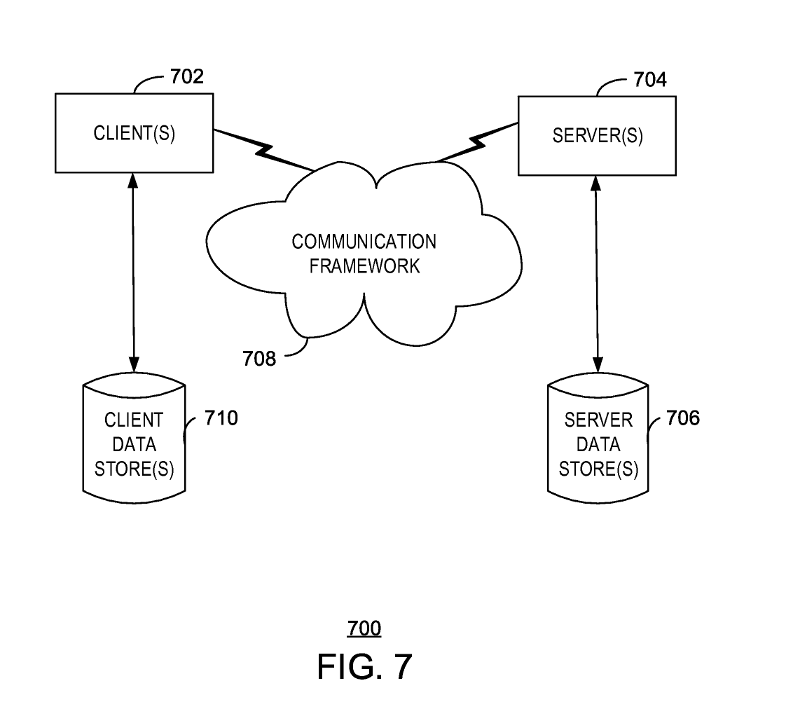

FIG. 7 is a block diagram of an exemplary networking environment 700 for implementing various aspects of the claimed subject matter. Moreover, the exemplary networking environment 700 may be used to implement a system and method that process external datasets with a DBMS engine.

The networking environment 700 includes one or more client(s) 702. The client(s) 702 can be hardware and/or software (e.g., threads, processes, computing devices). As an example, the client(s) 702 may be client devices, providing access to server 704, over a communication framework 708, such as the Internet.

The environment 700 also includes one or more server(s) 704. The server(s) 704 can be hardware and/or software (e.g., threads, processes, computing devices). The server(s) 704 may include a server device. The server(s) 704 may be accessed by the client(s) 702.

One possible communication between a client 702 and a server 704 can be in the form of a data packet adapted to be transmitted between two or more computer processes. The environment 700 includes a communication framework 708 that can be employed to facilitate communications between the client(s) 702 and the server(s) 704.

The client(s) 702 are operably connected to one or more client data store(s) 710 that can be employed to store information local to the client(s) 702. The client data store(s) 710 may be located in the client(s) 702, or remotely, such as in a cloud server. Similarly, the server(s) 704 are operably connected to one or more server data store(s) 706 that can be employed to store information local to the servers 704.

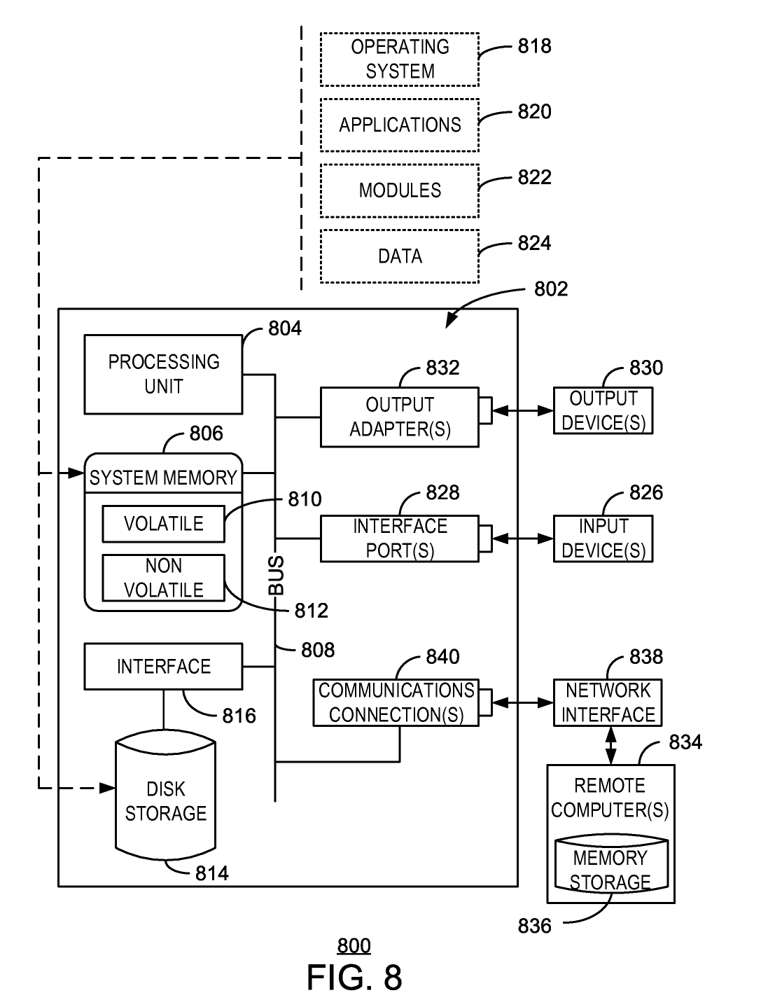

In order to provide context for implementing various aspects of the claimed subject matter, FIG. 8 is intended to provide a brief, general description of a computing environment in which the various aspects of the claimed subject matter may be implemented. For example, a method and system for systematic analyses for a range of attacks in the cloud network, can be implemented in such a computing environment. While the claimed subject matter has been described above in the general context of computer-executable instructions of a computer program that runs on a local computer or remote computer, the claimed subject matter also may be implemented in combination with other program modules. Generally, program modules include routines, programs, components, data structures, or the like that perform particular tasks or implement particular abstract data types.

FIG. 8 is a block diagram of an exemplary operating environment 800 for implementing various aspects of the claimed subject matter. The exemplary operating environment 800 includes a computer 802. The computer 802 includes a processing unit 804, a system memory 806, and a system bus 808.

The system bus 808 couples system components including, but not limited to, the system memory 806 to the processing unit 804. The processing unit 804 can be any of various available processors. Dual microprocessors and other multiprocessor architectures also can be employed as the processing unit 804.

The system bus 808 can be any of several types of bus structure, including the memory bus or memory controller, a peripheral bus or external bus, and a local bus using any variety of available bus architectures known to those of ordinary skill in the art. The system memory 806 includes computer-readable storage media that includes volatile memory 810 and nonvolatile memory 812.

The basic input/output system (BIOS), containing the basic routines to transfer information between elements within the computer 802, such as during start-up, is stored in nonvolatile memory 812. By way of illustration, and not limitation, nonvolatile memory 812 can include read only memory (ROM), programmable ROM (PROM), electrically programmable ROM (EPROM), electrically erasable programmable ROM (EEPROM), or flash memory.

Volatile memory 810 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 802 also includes other computer-readable media, such as removable/non-removable, volatile/non-volatile computer storage media. FIG. 8 shows, for example a disk storage 814. Disk storage 814 includes, but is not limited to, devices like a magnetic disk drive, floppy disk drive, tape drive, Jaz drive, Zip drive, LS-210 drive, flash memory card, or memory stick.

In addition, disk storage 814 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 814 to the system bus 808, a removable or non-removable interface is typically used such as interface 816.

It is to be appreciated that FIG. 8 describes software that acts as an intermediary between users and the basic computer resources described in the suitable operating environment 800. Such software includes an operating system 818. Operating system 818, which can be stored on disk storage 814, acts to control and allocate resources of the computer system 802.

System applications 820 take advantage of the management of resources by operating system 818 through program modules 822 and program data 824 stored either in system memory 806 or on disk storage 814. It is to be appreciated that the claimed subject matter can be implemented with various operating systems or combinations of operating systems.

A user enters commands or information into the computer 802 through input devices 826. Input devices 826 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. The input devices 826 connect to the processing unit 804 through the system bus 808 via interface ports 828. Interface ports 828 include, for example, a serial port, a parallel port, a game port, and a universal serial bus (USB).

Output devices 830 use some of the same type of ports as input devices 826. Thus, for example, a USB port may be used to provide input to the computer 802, and to output information from computer 802 to an output device 830.

Output adapter 832 is provided to illustrate that there are some output devices 830 like monitors, speakers, and printers, among other output devices 830, which are accessible via adapters. The output adapters 832 include, by way of illustration and not limitation, video and sound cards that provide a means of connection between the output device 830 and the system bus 808. It can be noted that other devices and systems of devices provide both input and output capabilities such as remote computers 834.

The computer 802 can be a server hosting various software applications in a networked environment using logical connections to one or more remote computers, such as remote computers 834. The remote computers 834 may be client systems configured with web browsers, PC applications, mobile phone applications, and the like.

The remote computers 834 can be a personal computer, a server, a router, a network PC, a workstation, a microprocessor based appliance, a mobile phone, a peer device or other common network node and the like, and typically includes many or all of the elements described relative to the computer 802.

For purposes of brevity, a memory storage device 836 is illustrated with remote computers 834. Remote computers 834 is logically connected to the computer 802 through a network interface 838 and then connected via a wireless communication connection 840.

Network interface 838 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connections 840 refers to the hardware/software employed to connect the network interface 838 to the bus 808. While communication connection 840 is shown for illustrative clarity inside computer 802, it can also be external to the computer 802. The hardware/software for connection to the network interface 838 may include, for exemplary purposes, internal and external technologies such as, mobile phone switches, modems including regular telephone grade modems, cable modems and DSL modems, ISDN adapters, and Ethernet cards.

An exemplary processing unit 804 for the server may be a computing cluster comprising Intel® Xeon CPUs. The disk storage 814 may comprise an enterprise data storage system, for example, holding thousands of impressions.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

### Examples

Examples of the claimed subject matter may include any combinations of the methods and systems shown in the following numbered paragraphs. This is not considered a complete listing of all possible examples, as any number of variations can be envisioned from the description above.

One example includes a method for detecting attacks on a data center. The method includes sampling a packet stream at multiple levels of data center architecture, based on specified parameters. The method also includes processing the sampled packet stream to identify one or more data center attacks. The method also includes generating one or more attack notifications for the identified data center attacks. In this way, example methods may save computer resources by detecting a wider array of attacks than current techniques. Further, in detecting more attacks, costs may be reduced by using example methods, as opposed to buying multiple tools, each configured to detect only one attack type.

Another example includes the above method, and determining granular traffic volumes of the packet stream for a plurality of specified time granularities. The example method also includes processing the sampled packet stream occurring across one or more of the specified time granularities based on the sampled packet stream.

Another example includes the above method, and processing the sampled packet stream. Processing the sampled packet stream includes determining a relative change in the granular traffic volumes. The example method also includes determining a volumetric-based attack is occurring based on the relative increase.

Another example includes the above method, where processing the sampled packet stream includes determining an absolute change in the granular traffic volumes. Processing also includes determining a volumetric-based attack is occurring based on the absolute change.

Another example includes the above method, where processing the sampled packet stream includes determining fan-in/fan-out ratio for inbound and outbound packets. Another example includes the above method, and determining an IP address is under attack based on the fan-in/fan-out ratio for the IP address. Another example includes the above method, and identifying the data center attacks based on TCP flag signatures.

Another example includes the above method, and filtering a packet stream of packets from blacklisted nodes. The blacklisted nodes are identified based on a plurality of blacklists comprising traffic distribution system (TDS) nodes and spam nodes.

Another example includes the above method, and filtering a packet stream of packets not from whitelisted nodes. The whitelisted nodes are identified based on a plurality of whitelists comprising trusted nodes.

Another example includes the above method, and the data center attacks being identified in real time. Another example includes the above method, and the data center attacks being identified offline.

Another example includes the above method, and the data center attacks comprising an inbound attack. Another example includes the above method, and the data center attacks comprising an outbound attack. Another example includes the above method, and the data center attacks comprising an intra-datacenter attack.

Another example includes a system for detecting attacks on a data center of a cloud service. The system includes a distributed architecture comprising a plurality of computing units. Each of the computing units includes a processing unit and a system memory. The computing units include an attack detection engine executed by one of the processing units. The attack detection engine includes a sampler to sample a packet stream at multiple levels of a data center architecture, based on a plurality of specified time granularities. The engine also includes a controller to determine, based on the packet stream, granular traffic volumes for the specified time granularities. The controller also identifies, in real-time, a plurality of data center attacks occurring across one or more of the specified time granularities based on the sampling. The controller also generates a plurality of attack notifications for the data center attacks.

Another example includes the above system, and the network attack being identified as one or more volume-based attacks based on a specified percentile of packets over a specified duration.

Another example includes the above system, and the network attack being identified by determining a relative change in the granular traffic volumes, and determining a volumetric-based attack is occurring based on the relative change, the relative change comprising either an increase or a decrease.

Another example includes one or more computer-readable storage memory devices for storing computer-readable instructions. The computer-readable instructions when executed by one or more processing devices, the computer-readable instructions include code configured to determine, based on a packet stream for the data center, granular traffic volumes for a plurality of specified time granularities. The code is also configured to sample the packet stream at multiple levels of data center architecture, based on the specified time granularities. The code is also configured to identify a plurality of data center attacks occurring across one or more of the specified time granularities based on the sampling. Additionally, the code is configured to generate a plurality of attack notifications for the data center attacks.

Another example includes the above memory devices, and the code is configured to identify the plurality of attacks in real-time and offline. Another example includes the above method, and the attacks comprising inbound attacks, outbound attacks, and intra-datacenter attacks.

What is claimed is:

1. A method for detecting attacks on a data center, comprising:
sampling a packet stream by coordinating at multiple levels of data center architecture, based on specified parameters;
processing the sampled packet stream to identify one or more data center attacks; and
generating one or more attack notifications for the identified data center attacks.

2. The method of claim 1, comprising:
determining granular traffic volumes of the packet stream for a plurality of specified time granularities; and
processing the sampled packet stream occurring across one or more of the specified time granularities to identify the data center attacks.

3. The method of claim 2, processing the sampled packet stream comprising:
determining a relative change in the granular traffic volumes; and
determining a volumetric-based attack is occurring based on the relative change.

4. The method of claim 2, processing the sampled packet stream comprising:
determining the granular traffic volumes exceed a specified threshold; and
determining a volumetric-based attack is occurring based on the determination.

5. The method of claim 1, processing the sampled packet stream comprising:
determining fan-in/fan-out ratio for inbound and outbound packets; and
determining an IP address is under attack based on the fan-in/fan-out ratio for the IP address.

6. The method of claim 1, identifying the data center attacks based on TCP flag signatures.

7. The method of claim 1, comprising:
filtering a packet stream of packets from blacklisted nodes, the blacklisted nodes being identified based on a plurality of blacklists comprising traffic distribution system (TDS) nodes and spam nodes; and
filtering a packet stream of packets not from whitelisted nodes, the whitelisted nodes being identified based on a plurality of whitelists comprising trusted nodes.

8. The method of claim 1, the data center attacks being identified in real time.

9. The method of claim 1, the data center attacks being identified offline.

10. The method of claim 1, the data center attacks comprising an inbound attack.

11. The method of claim 1, the data center attacks comprising an outbound attack.

12. The method of claim 1, the data center attacks comprising an inter-datacenter attack, and an intra-datacenter attack.

13. The method of claim 1, coordinating comprising sampling, at each level, a plurality of specified IP addresses of network traffic.

14. The method of claim 1, the data center attacks comprising an attack on a cloud infrastructure comprising the data center.

15. A system for detecting attacks on a data center of a cloud service, comprising:
a distributed architecture comprising a plurality of computing units, each of the computing units comprising:
a processing unit; and
a system memory, the computing units comprising an attack detection engine executed by one of the processing units, the attack detection engine comprising:
a sampler to sample a packet stream in coordination at multiple levels of a data center architecture, based on a plurality of specified time granularities; and
a controller configured to:
determine, based on the packet stream, granular traffic volumes for the specified time granularities;
identify a plurality of data center attacks occurring across one or more of the specified time granularities based on the sampling; and
generate a plurality of attack notifications for the data center attacks.

16. The system of claim 15, the network attack being identified as one or more volume-based attacks based on a specified percentile of traffic distribution over a specified duration.

17. The system of claim 15, coordination comprising sampling, at each level, a plurality of specified IP addresses of inbound network traffic.

18. One or more computer-readable storage memory devices for storing computer-readable instructions, the computer-readable instructions when executed by one or more processing devices, the computer-readable instructions comprising code configured to:
determine, based on a packet stream for the data center, granular traffic volumes for a plurality of specified time granularities;
sample the packet stream using coordination at multiple levels of data center architecture, based on the specified time granularities;
identify a plurality of data center attacks occurring across one or more of the specified time granularities based on the sampling; and
generate a plurality of attack notifications for the data center attacks.

19. The computer-readable storage memory devices of claim 18, the code configured to identify the plurality of attacks in real-time and offline.

20. The computer-readable storage memory devices of claim 18, coordination comprising sampling, at each level, a plurality of specified IP addresses associated with:
outbound network traffic; or
inbound network traffic.
